(19) United States
(12) Patent Application Publication
(10) Pub. No.: US 2026/0342477 A1
(43) Pub. Date: Oct. 29, 2026

(54) REDUCED COMPLEXITY LLR CALCULATION FOR IQ-DEPENDENT BIT-TO-CONSTELLATION SYMBOL MAPPINGS

(71) Applicant: QUALCOMM Incorporated, San Diego, CA (US)

(72) Inventor: Ronen SHAKED, Kfar Saba, Haifa District (IL)

(21) Appl. No.: 19/104,015

(22) PCT Filed: Sep. 8, 2023
(86) PCT No.: PCT/US2023/032352

§ 371 Date: Feb. 14, 2025

(30) Foreign Application Priority Data
Sep. 16, 2022 (IL) 296560

(51) Int. Cl. H04L 1/00

(52) U.S. Cl. CPC H04L 1/0054; H04L 1/0003; H04L 1/0009

(57) ABSTRACT

Apparatus, methods, and computer program products for log-likelihood ratio (LLR) calculation are provided. An example method may include transmitting, for a network entity, an indication representing support of one or more constellations associated with a multi-dimensional LLR calculation. The example method may further include obtaining a modulation and coding scheme (MCS) configuration for each constellation of the one or more constellations. The example method may further include receiving, from the network entity, a communication after the MCS configuration is obtained. The example method may further include decoding the communication based on the MCS configuration and the multi-dimensional LLR calculation based on a set of neighbor bits for a bit in the communication, where a quantity of the set of neighbor bits is associated with the MCS configuration.

### CROSS-REFERENCE TO RELATED APPLICATION

This application claims the benefit of Israel Patent Application Serial No. 296560, entitled “REDUCED COMPLEXITY LLR CALCULATION FOR IQ-DEPENDENT BIT-TO-CONSTELLATION SYMBOL MAPPINGS” and filed on Sep. 16, 2022, which is expressly incorporated by reference herein in its entirety.

### TECHNICAL FIELD

The present disclosure relates generally to communication systems, and more particularly, to wireless communication systems with log-likelihood ratio (LLR) calculation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a wireless device (such as a user equipment (UE) or a network entity) are provided. The apparatus may include a memory and at least one processor coupled to the memory. The memory and the at least one processor coupled to the memory may be configured to transmit, for a network entity, an indication representing support of one or more constellations associated with a multi-dimensional log-likelihood ratio (LLR) calculation. The memory and the at least one processor coupled to the memory may be further configured to obtain a modulation and coding scheme (MCS) configuration for each constellation of the one or more constellations. The memory and the at least one processor coupled to the memory may be further configured to receive, from the network entity, a communication after the MCS configuration is obtained. The memory and the at least one processor coupled to the memory may be further configured to decode the communication based on the MCS configuration and the multi-dimensional LLR calculation based on a set of neighbor bits for a bit in the communication, where a quantity of the set of neighbor bits is associated with the MCS configuration.

In another aspect of the disclosure, a method, a computer-readable medium, and an apparatus at a network entity are provided. The apparatus may include a memory and at least one processor coupled to the memory. The memory and the at least one processor coupled to the memory may be configured to obtain an indication representing support of one or more constellations associated with multi-dimensional LLR calculation associated with a wireless device. The memory and the at least one processor coupled to the memory may be further configured to transmit, for the wireless device, a MCS configuration for each constellation of the one or more constellations for decoding a communication based on a set of neighbor bits for a bit in the communication, where a quantity of the set of neighbor bits is associated with the MCS configuration. The memory and the at least one processor coupled to the memory may be further configured to transmit, for the wireless device, the communication after the MCS configuration is transmitted.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating example LLR for square quadrature amplitude modulation (QAM).

FIG. 4B is a diagram illustrating example LLR for square QAM.

FIG. 4C is a diagram illustrating example LLR for square QAM.

FIG. 4D is a diagram illustrating example LLR for square QAM.

FIG. 5A is a diagram illustrating example mapping of bits in square QAM.

FIG. 5B is a diagram illustrating example mapping of bits in square QAM.

FIG. 5C is a diagram illustrating example mapping of bits in square QAM.

FIG. 5D is a diagram illustrating example mapping of bits in square QAM.

FIG. 6A is a diagram illustrating example mapping of bits in circular QAM.

FIG. 6B is a diagram illustrating example LLR calculation for circular QAM.

FIG. 7 is a diagram illustrating example mapping of bits in hexagonal QAM.

FIG. 8 is a diagram illustrating example communications between a network entity and a wireless device.

FIG. 9 is a diagram illustrating example calculation of LLR.

FIG. 10A is a diagram illustrating example calculation of LLR.

FIG. 10B is a diagram illustrating example calculation of LLR.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

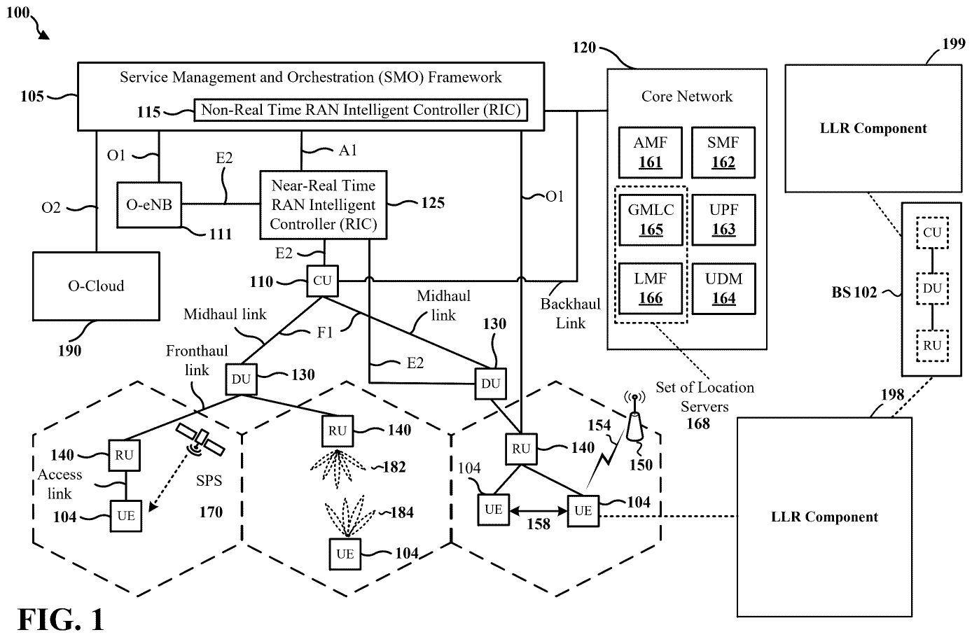

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 or another wireless device may include a LLR component 198. In some aspects, the LLR component 198 may be configured to transmit, for a network entity, an indication representing support of one or more constellations associated with a multi-dimensional LLR calculation. In some aspects, the LLR component 198 may be further configured to obtain a MCS configuration for each constellation of the one or more constellations. In some aspects, the LLR component 198 may be further configured to receive, from the network entity, a communication after the MCS configuration is obtained. In some aspects, the LLR component 198 may be further configured to decode the communication based on the MCS configuration and the multi-dimensional LLR calculation based on a set of neighbor bits for a bit in the communication, where a quantity of the set of neighbor bits is associated with the MCS configuration.

In certain aspects, the base station 102 may include a LLR component 199. In some aspects, the LLR component 199 may be configured to obtain an indication representing support of one or more constellations associated with multi-dimensional LLR calculation associated with a wireless device. In some aspects, the LLR component 199 may be further configured to transmit, for the wireless device, a MCS configuration for each constellation of the one or more constellations for decoding a communication based on a set of neighbor bits for a bit in the communication, where a quantity of the set of neighbor bits is associated with the MCS configuration. In some aspects, the LLR component 199 may be further configured to transmit, for the wireless device, the communication after the MCS configuration is transmitted.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

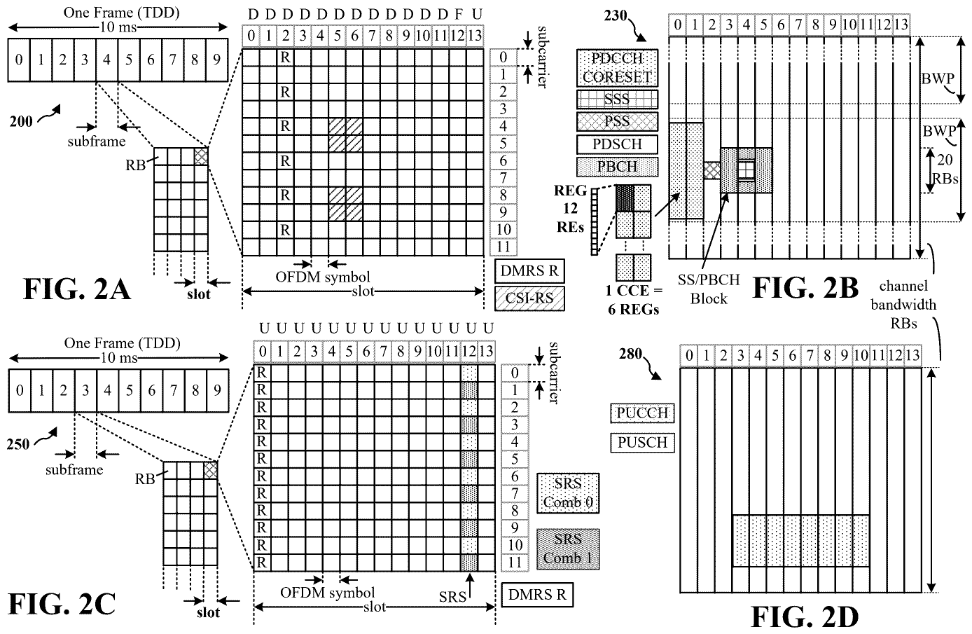

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δƒ = 2^{μ} · 15 [KHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

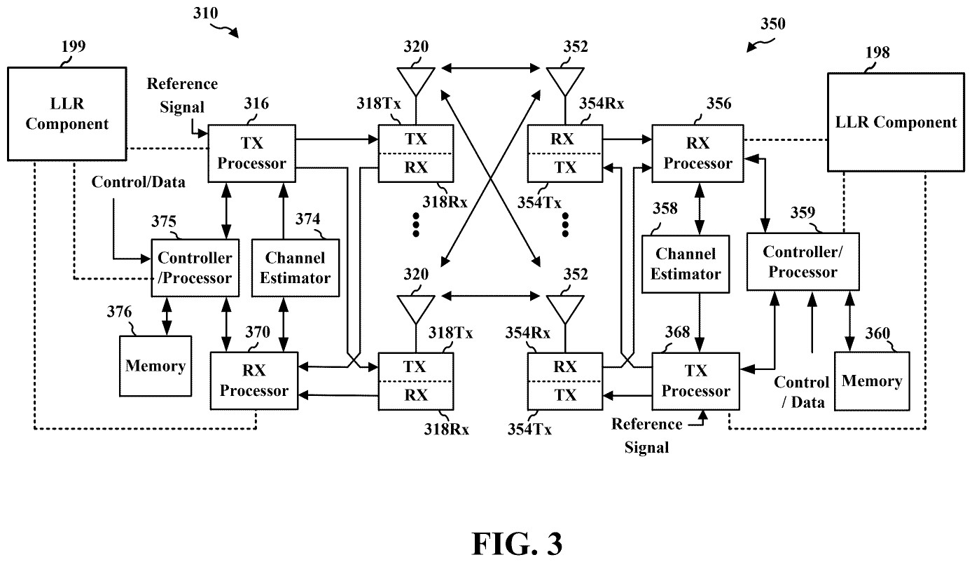

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with LLR component 198 of FIG. 1.

At least one of the TX processor 316, the RX processor 370, and the controller/processor 375 may be configured to perform aspects in connection with LLR component 199 of FIG. 1.

In communication systems, LLR may be a unit representing the reliability level per bit and may be used as an input for a soft decoder such as low-density-parity-check (LDPC), Turbo code, or the like. LDPC may be a linear error correcting code and may be defined by a sparse parity-check matrix. Based on LDPC, During the encoding of data, the input data bits (D) are repeated and distributed to a set of constituent encoders. The constituent encoders may be accumulators and each accumulator may be used to generate a parity symbol. A single copy of the original data (S_{0,K-1}) may be transmitted with the parity bits (P) to make up the code symbols. The S bits from each constituent encoder are discarded. Turbo code may be forward error correction codes. As an example, at an encoder, different sub-blocks of bits may be used. A first sub-block may be a m-bit block of payload data, a second sub-block is n/2 parity bits for the payload data, computed using a recursive systematic convolutional code, a third sub-block may be n/2 parity bits for a known permutation of the payload data computed using the recursive systematic convolutional code. Therefore, two different redundant sub-blocks of parity bits are sent with the payload.

As described herein, LLR calculation may be performed at the receiving device as part of decoding. The calculation of LLR may be based on two parameters. A first parameter may be the symbol in-phase (I) quadrature (Q) (IQ) mapping (e.g., the different complex IQ values that a symbol takes) and the second parameter may be the bit to symbol mapping (e.g., the bit string attached to each symbol). Quadrature amplitude modulation (QAM) is a method of combining two amplitude modulation (AM) signals into a single channel. In a QAM signal, one carrier lags the other by 90° and its amplitude modulation may be referred to as in-phase component while the other modulation function may be referred to as the quadrature component. As used herein, the term “constellation” may refer to constellations in a constellation graph that represents signal modulated by a digital modulation scheme such as QAM or phase shift keying. In a constellation graph, each point may represent a symbol and may be referred to as a “constellation.” Example constellation types may include square constellation (where the constellations are represented by points in a square), circular constellation (where the constellations are represented by points in a circular shape), hexagonal constellation (where the constellations are represented by points in a hexagonal shape), or the like. As used herein, the term “support of one or more constellations” may refer to a representation of a device's capability of supporting one or more constellation types, such as circular constellation, hexagonal constellation, or the like.

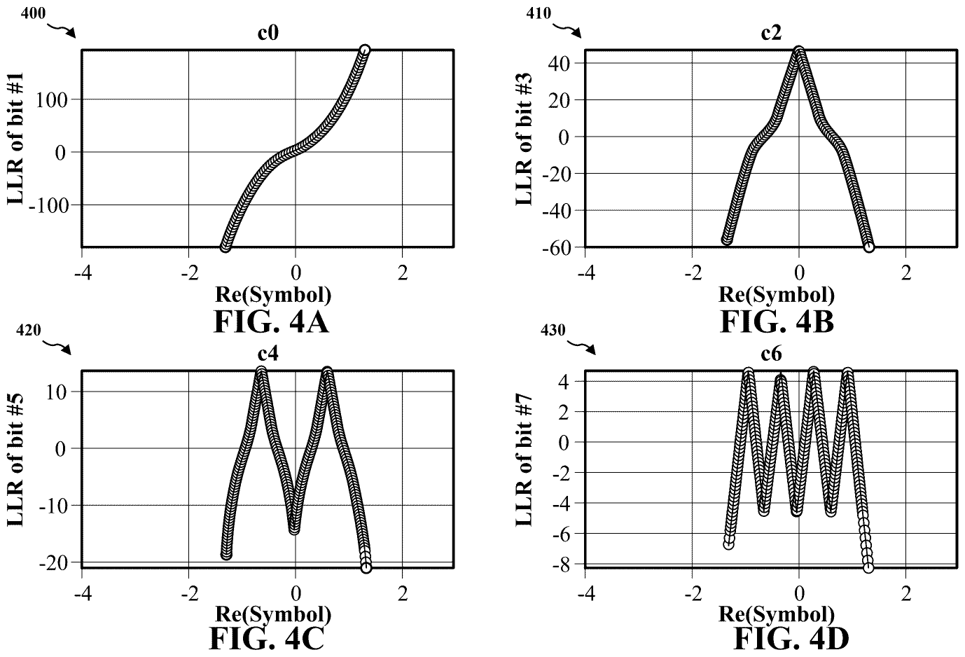

In square QAM (e.g., 16,64,256,1024 QAM or the like such as other modulation order (log₂(constellation)) is even), LLR calculation may be relatively simple and less computing resource consuming because the calculation degenerates to a one-dimensional (1D) calculation. For example, LLR for bit cᵢ (represented by LLR_{bit c}_{ᵢ}) depends solely either on I or Q, but not on both: LLR^{bit c}ᵢ=func (i) or func (q). The parameter func represents a function. FIG. 4A is a diagram 400 illustrating example LLR for square QAM. As illustrated in FIG. 4A, for bit c0, there may be a first function. FIG. 4B is a diagram 410 illustrating example LLR for square QAM. As illustrated in FIG. 4B, for bit c2, there may be a second function. FIG. 4C is a diagram 420 illustrating example LLR for square QAM. As illustrated in FIG. 4C, for bit c6, there may be a third function. FIG. 4D is a diagram 430 illustrating example LLR for square QAM. As illustrated in FIG. 4D, for bit c8, there may be a fourth function.

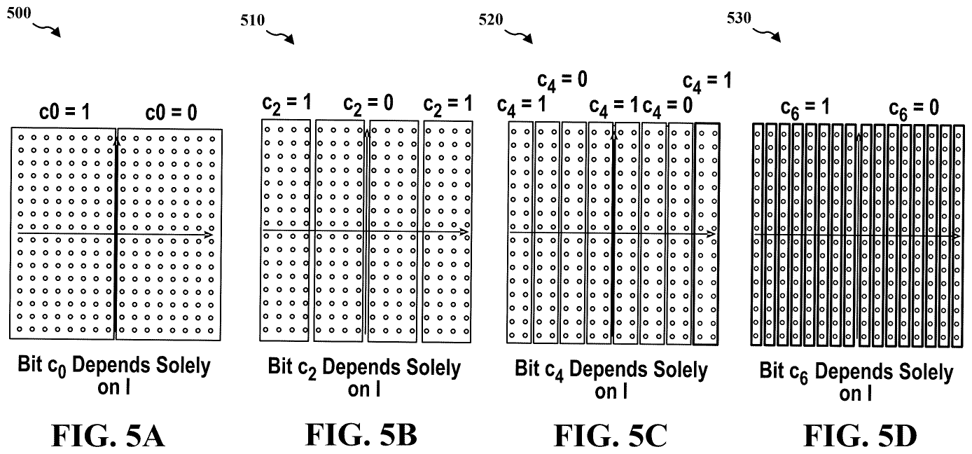

For square QAM, LLR calculation is based on either I or Q because the bit mapping in square QAM allows for every bit to depend solely on either I or Q. FIG. 5A is a diagram 500 illustrating example mapping of bits in square QAM. As illustrated in FIG. 5A, bit c0 depends solely on I. FIG. 5B is a diagram 510 illustrating example mapping of bits in square QAM. As illustrated in FIG. 5B, bit c2 depends solely on I. FIG. 5C is a diagram 520 illustrating example mapping of bits in square QAM. As illustrated in FIG. 5C, bit c4 depends solely on I. FIG. 5D is a diagram 530 illustrating example mapping of bits in square QAM. As illustrated in FIG. 5D, bit c8 depends solely on I. Similarly, bit c1, bit c3, bit c5, and bit c7 depends solely on Q.

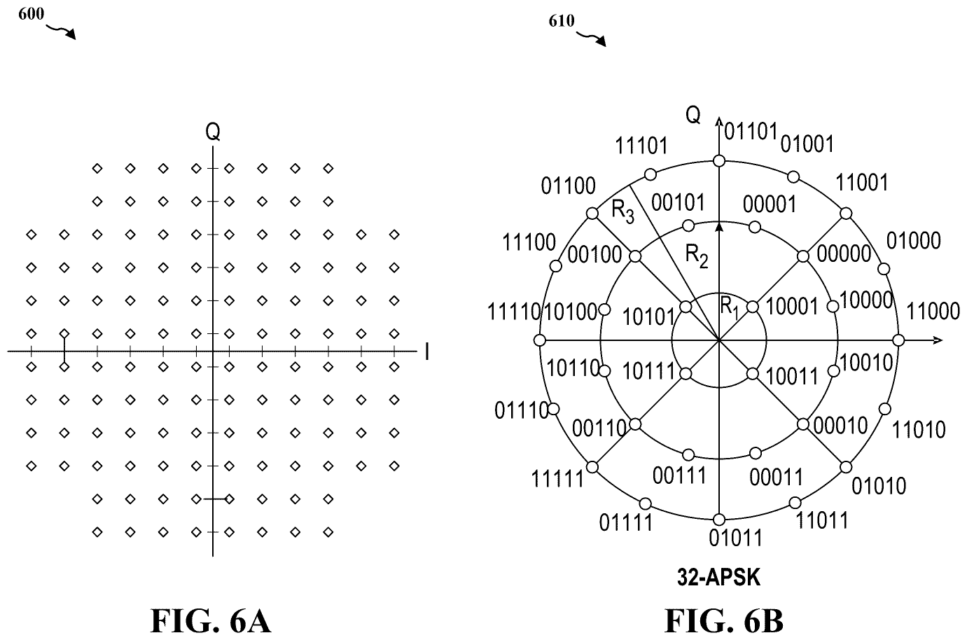

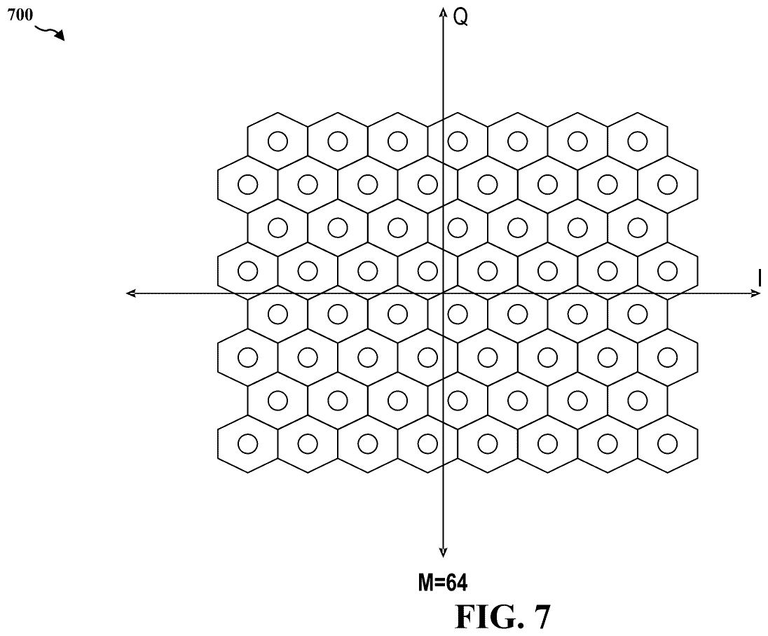

Generally, for some constellation types, some bits to symbol mapping may be such that LLR calculation can be separated to be dependent solely on I or Q but not on both, which makes the LLR calculation to be 1D calculation but not multi-dimensional, such as two-dimensional (2D). However, for some constellation types, some bits to symbol mapping may be such that LLR calculation for some symbols may be dependent on I and Q so that 2D calculation may be used, resulting in much higher computation complexity that may use a lot of computing resources. For example, FIG. 6A is a diagram 600 illustrating example mapping of bits in circular QAM. FIG. 6B is a diagram 610 illustrating example LLR calculation for circular QAM. For such circular QAM, for some symbols, the LLR calculation may be based on both I and Q, resulting in 2D LLR calculations. As another example, multi-level coding, where the bits are partitioned into several levels (e.g., two levels) and each level may be decoded separately (e.g., sequentially), cases in order to guarantee good gray properties in all levels, the mapping may fail to satisfy each bit depending solely on I or Q, resulting in 2D LLR calculations. As another example, FIG. 7 is a diagram 700 illustrating example mapping of bits in hexagonal QAM. Hexagonal QAM may have better capacity to Shannon bound (maximum channel capacity being equal to bandwidth times log 2 of one plus signal to noise ratio). To perform 2D LLR calculations, the 2D LLR calculations may be too complicated to be carried out at a receiver of the wireless device. An example 2D LLR calculation may be:

$${LLR}_{bit {c}_{i}} = \frac{1}{{N}_{o}} [ {min}_{{s}_{i} ∈ C , {bitc}_{i} = 0} {\vert y - {s}_{i} \vert}^{2} - {min}_{{s}_{i} ∈ C , {bitc}_{i} = 1} {\vert y - {s}_{i} \vert}^{2} ] .$$

The symbols ∈ may represent belongs to. The parameter C may represent all bits. The parameter y may represent the bit in which the LLR calculation is for.

Multi-level coding may be used for reducing power consumption for wireless communication systems, such as sub-Terahertz (THz) communication with more than 90 GHz frequency. Non-square QAM such as circular constellation or hexagonal constellation QAM may allow for improved spectrum efficiency (SPEF) and better resiliency to phase noise in discrete Fourier transform spread orthogonal frequency division multiplexing (DFT-s-OFDM) or single carrier. Amplitude and phase-shift keying (APSK) may have better resiliency to power amplifier non-linearity because the radial constellation points density may be low (several radii), allowing for better inversion of power amplifier non-linearity in the receiver.

Aspects provided herein may enable multi-dimensional LLR calculations with reduced computational complexity, saving processing time and computing resources at the receiver. As used herein, the term “multi-dimensional LLR calculation” refers to LLR calculations that are not solely based on in-phase component or solely based on quadrature component. Without aspects provided herein, 2D LLR calculation may be based on dividing a constellation of size Q into two groups (each sized Q/2), and Q Euclidean distances may be calculated and minimization over Q/2 members may be done twice. The process may be repeated log 2 (Q) times because for each bit cᵢ, the 0 and 1 groups change. Aspects provided herein may allow much lower computational complexity where minimization over neighbor members (much lower quantity than Q/2) may be done.

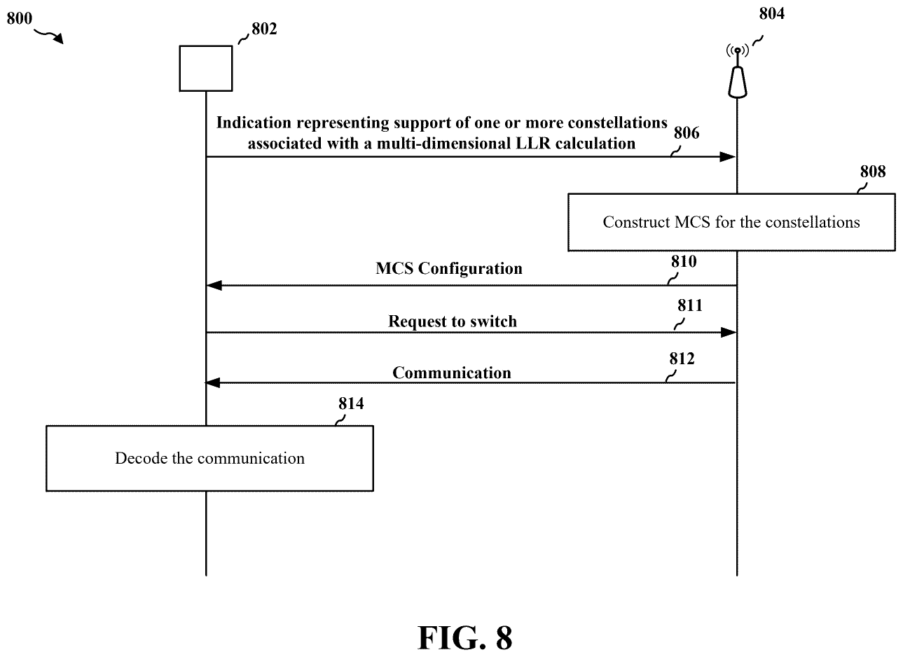

FIG. 8 is a diagram 800 illustrating example communications between a network entity 804 and a wireless device 802. In some aspects, the wireless device 802 may be a UE. In some aspects, the wireless device 802 may be a network entity. In some aspects, the network entity 804 may be implemented in an aggregated or monolithic base station architecture, or alternatively, in a disaggregated base station architecture, and may include one or more of a CU, a DU, an RU, a Near-Real Time (Near-RT) RAN Intelligent Controller (RIC), or a Non-Real Time (Non-RT) RIC.

As illustrated in FIG. 8, in some aspects, the wireless device 802 may transmit an indication 806 representing support of one or more constellations associated with multi-dimensional (e.g., 2D) LLR calculation to the network entity 804. In some aspects, the one or more constellations may include hexagonal constellation, circular hexagonal constellation, constellation for multi-level coding, or the like. In some aspects, the indication 806 may be a list of supported constellations that may include hexagonal constellation, circular hexagonal constellation, constellation for multi-level coding, or the like.

In some aspects, upon receiving the indication 806, the network entity 804 may, at 808, construct an MCS table for the wireless device 802 for the supported constellations. In some aspects, the MCS table may be per wireless device and may be associated with the wireless device 802. After constructing the MCS table for the wireless device 802, the network entity 804 may transmit a MCS configuration 810 including the MCS table to the wireless device 802. As used herein, the term “MCS configuration” may refer to a configuration defining different parameters for different modulation schemes, example parameters may include phase and amplitude for bit computing, coding rate of bits and error correction, data width, guard interval, minimum signal to noise ration and reference signal strength indicator (RSSI), number of spatial streams, data rate, number of coded bits per symbol, number of data subcarriers, number of encoders used, or the like. In some aspects, in addition to the supported constellations that use multi-dimensional LLR calculation, other constellation types, such as square constellation, may also be configured in the MCS configuration 810.

In general, constellations that use multi-dimensional LLR calculation may be more resilient to phase noise. For example, when going to high order modulation and phase noise becomes dominant over thermal noise it is worthwhile for the wireless device 802 to switch to the MCS based on constellations that use multi-dimensional LLR calculation. In another example, when the wireless device 802 is at a cell edge and the wireless device 802 would use transmit power boost (e.g., through repeater or directly from the network entity 804), then non-linearity might be present and modulations more resilient to non-linearity such APSK may be beneficial. In some aspects, the wireless device 802 may request (e.g., by transmitting a request 811) to the network entity 804 to switch to MCS configuration 810 with constellations that are based on multi-dimensional LLR calculations.

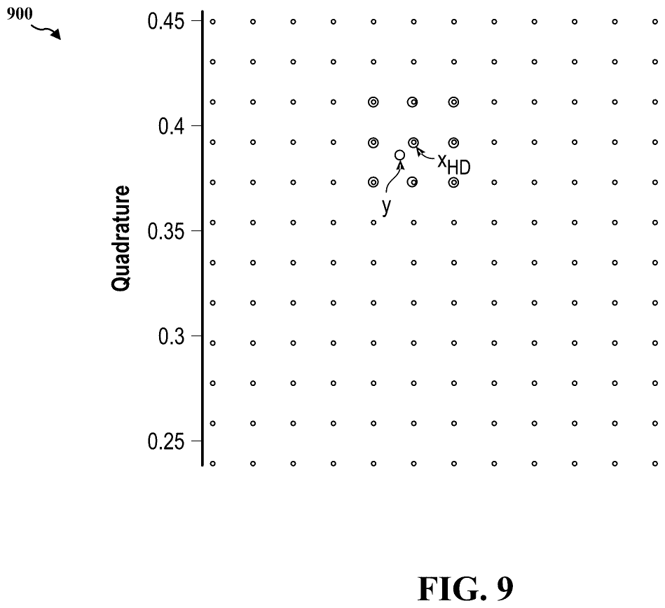

In some aspects, the network entity 804 may transmit a communication 812 to the wireless device 802 and the wireless device 802 may accordingly decode the communication at 814. In some aspects, to decode the communication at 814, the wireless device 802 may use a multi-dimensional LLR calculation based on minimization over neighbor members (lower quantity than Q/2, Q being the constellation size) may be done. In some aspects, for each symbol, the wireless device 802 may apply a hard decision over a received soft noisy symbol (represented by y) of the communication: X_{hd}=hard_slicer (y). The parameter X_{hd} may represent the output of the hard slicer. The parameter X_{hd} may be used as an input to a lookup table which may output a number of closes neighbors N_{neighbors}. In some aspects, the lookup table may be configured by the MCS configuration 810 and may be associated with the constellation. As an example, the number of neighbors N_{neighbors} may be 9 or 16 for QAM because 9 neighbors wrap around the vicinity of the received symbol. FIG. 9 is a diagram 900 illustrating example calculation of LLR. As illustrated in FIG. 9, for a received symbol y, hard decision may be applied to generate X_{hd} and 9 neighbors of X_{hd} may be selected. In some aspects, the lookup table may include the neighbors' IQ value and their associated bit mapping (e.g., bit labeling). In some aspects, in order to calculate LLR for bit #i, the neighbors may be split into two groups: group at which bit #i is 0 (referred to as group 0) and denoted by k₀ and group at which bit #i is 1 (referred to as group 1) and denoted by k₁. The LLR may be then calculated in 2D but over a smaller number of members. Based on aspects provided herein, instead of calculating over Q members (e.g., Q=1024), the N_{neighbors} members (e.g., 9 or 16) may be calculated. An example 2D LLR calculation may be:

$$LL {R}_{bit {c}_{i}} = \frac{1}{{N}_{o}} [ {min}_{{s}_{i} ∈ {k}_{0}} {\vert y - {s}_{i} \vert}^{2} - {min}_{{s}_{i} ∈ {k}_{1}} {\vert y - {s}_{i} \vert}^{2} ] .$$

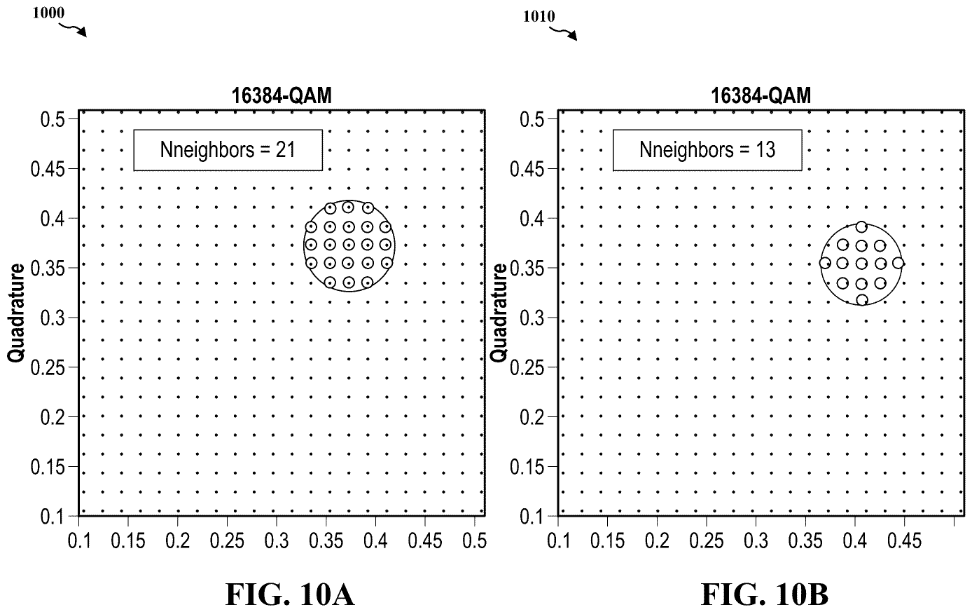

In some aspects, the neighbors may be selected based on a circle shaped pattern or a square shaped pattern. FIG. 10A is a diagram 1000 illustrating example calculation of LLR and selection of neighbors. As illustrated in FIG. 10A, 21 neighbors may be selected and the neighbors may be selected based on a circular shape. FIG. 10B is a diagram 1010 illustrating example calculation of LLR and selection of neighbors. As illustrated in FIG. 10B, 13 neighbors may be selected and the neighbors may be selected based on a circular shape.

In some aspects, it may be possible that none of the selected neighbors carries the value of bit 0 or bit 1. In such cases, group k₀ or group k₁ may be empty. In such cases,

$${min}_{{s}_{i} ∈ {k}_{0}} {\vert y - {s}_{i} \vert}^{2} or {min}_{{s}_{i} ∈ {k}_{1}} {\vert y - {s}_{i} \vert}^{2}$$

may be replaced by a larger constant E², where E represents a largest distance from X_{HD} to one of the neighbors of value of bit 0 or bit 1. In other words, neighbors may be selected based on a largest distance from hard slicing on the received symbol to a neighbor of bit 0 or bit value 1 to ensure that neither group k₀ nor group k₁ may be empty.

In some aspects, the wireless device 802 may compute and store two list of neighbors including one list of closest neighbors whose relevant bit is 0 (group k₀) and a second list of closest neighbors whose relevant bit is 1 (group k₁). Then the wireless device may select neighbors based on two neighbor sizes (or one combined size) and for group k₀ and k₀. Because there are two lists of neighbors and neighbors are selected from both lists, neither group k₀ nor group k₁ may be empty.

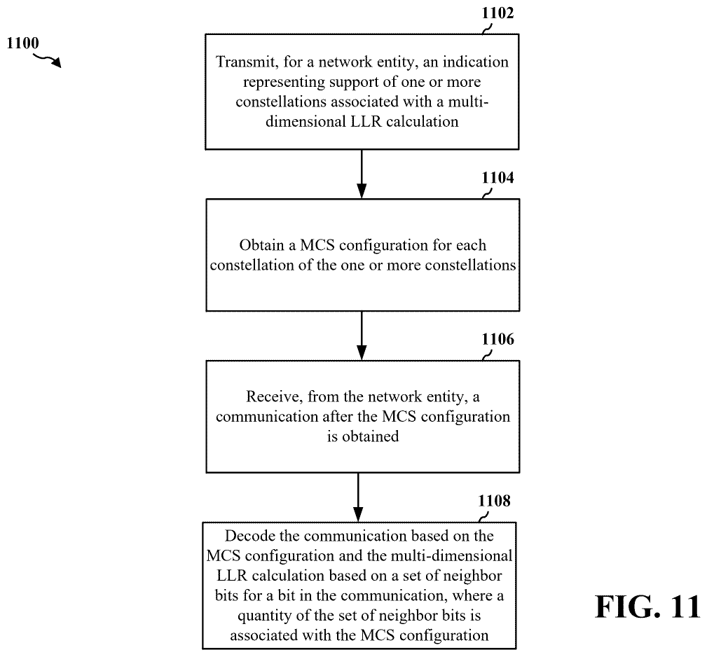

FIG. 11 is a flowchart 1100 of a method of wireless communication. The method may be performed by a wireless device (e.g., the UE 104, the wireless device 802; the apparatus 1304).

At 1102, the wireless device may transmit, for a network entity, an indication representing support of one or more constellations associated with a multi-dimensional LLR calculation. For example, the wireless device 802 may transmit, for a network entity 804, an indication (e.g., 806) representing support of one or more constellations associated with a multi-dimensional LLR calculation. In some aspects, 1102 may be performed by LLR component 198. In some aspects, the multi-dimensional LLR calculation includes two-dimensional (2D) LLR calculation. In some aspects, the one or more constellations includes a circular constellation, and where the set of neighbor bits are shaped in a circle around the bit or shaped in a square around the bit. As used herein, the term “neighbor bits” may refer to one or more bits that are near a bit by a distance.

At 1104, the wireless device may obtain a MCS configuration for each constellation of the one or more constellations. For example, the wireless device 802 may obtain a MCS configuration 810 for each constellation of the one or more constellations. In some aspects, 1104 may be performed by LLR component 198. In some aspects, the MCS configuration is an MCS table constructed for the wireless device. In some aspects, to obtain the MCS configuration for each constellation of the one or more constellations, the UE may receive, from the network entity, the MCS configuration for each constellation of the one or more constellations.

At 1106, the wireless device may receive, from the network entity, a communication after the MCS configuration is obtained. For example, the wireless device 802 may receive, from the network entity 804, a communication 812 after the MCS configuration 810 is obtained. In some aspects, 1106 may be performed by LLR component 198.

At 1108, the wireless device may decode the communication based on the MCS configuration and the multi-dimensional LLR calculation based on a set of neighbor bits for a bit in the communication, where a quantity of the set of neighbor bits is associated with the MCS configuration. For example, the wireless device 802 may decode the communication (e.g., at 814) based on the MCS configuration 810 and the multi-dimensional LLR calculation based on a set of neighbor bits for a bit in the communication, where a quantity of the set of neighbor bits is associated with the MCS configuration. In some aspects, 1108 may be performed by LLR component 198. In some aspects, the quantity of the set of neighbor bits is less than half of a constellation size associated with the communication. In some aspects, the one or more constellations includes a circular constellation, and where the set of neighbor bits are shaped in a circle around the bit or shaped in a square around the bit.

In some aspects, to decode the communication, the wireless device may divide, for the bit, the set of neighbor bits into a first subset of neighbor bits of value zero and a second subset of neighbor bits of value one and perform the multi-dimensional LLR calculation for the bit based on the first subset of neighbor bits and the second subset of neighbor bits.

In some aspects, to decode the communication, the wireless device may determine the quantity of the set of neighbor bits based on a largest bit distance from the bit to a first neighbor bit of value zero and a second neighbor bit of value one. In some aspects, the quantity is equal to the largest bit distance multiplied by the largest bit distance (largest bit distance squared). Neighbor bits of value zero may refer to neighbor bits that have a value of zero. Neighbor bits of value one may refer to neighbor bits that have a value of one.

In some aspects, to decode the communication, the wireless device may determine and store, for the bit, the first subset of neighbor bits of value zero in the set of neighbor bits and determine a third subset of neighbor bits of value zero and perform the multi-dimensional LLR calculation for the bit based on the first subset of neighbor bits and the third subset of neighbor bits.

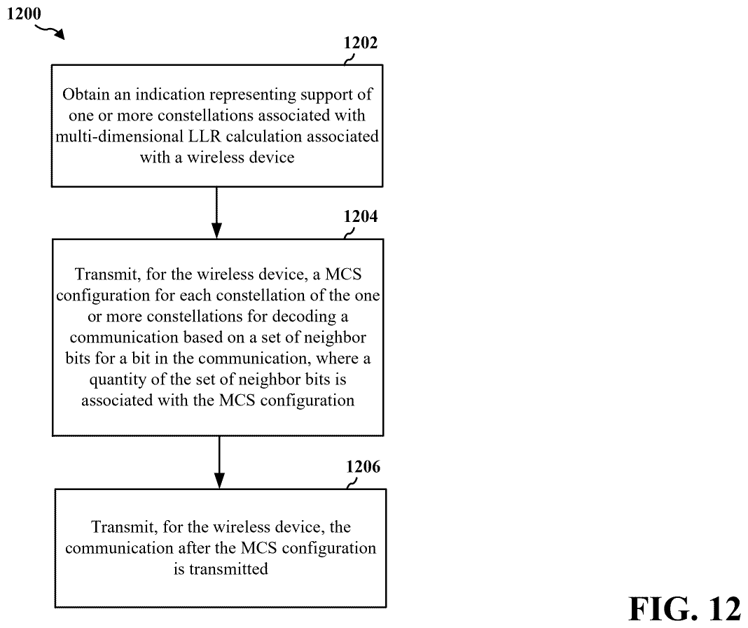

FIG. 12 is a flowchart 1200 of a method of wireless communication. The method may be performed by a network entity (e.g., the base station 102, the network entity 804, the network entity 1302, the network entity 1402).

At 1202, the network entity may obtain an indication representing support of one or more constellations associated with multi-dimensional LLR calculation associated with a wireless device. For example, the network entity 804 may obtain an indication (e.g., 806) representing support of one or more constellations associated with multi-dimensional LLR calculation associated with a wireless device. In some aspects, 1202 may be performed by LLR component 199. In some aspects, the multi-dimensional LLR calculation includes two-dimensional (2D) LLR calculation. In some aspects, the one or more constellations include at least one of: a circular constellation, a hexagonal constellation, or a constellation for multi-level coding. In some aspects, to obtain the indication representing support of the one or more constellations, the network entity may receive, from the wireless device, the indication representing support of the one or more constellations.

At 1204, the network entity may transmit, for the wireless device, a MCS configuration for each constellation of the one or more constellations for decoding a communication based on a set of neighbor bits for a bit in the communication, where a quantity of the set of neighbor bits is associated with the MCS configuration. For example, the network entity 804 may transmit, for the wireless device 802, a MCS configuration 810 for each constellation of the one or more constellations for decoding a communication based on a set of neighbor bits for a bit in the communication, where a quantity of the set of neighbor bits is associated with the MCS configuration. In some aspects, 1204 may be performed by LLR component 199. In some aspects, the MCS configuration is an MCS table constructed for the wireless device. In some aspects, the quantity of the set of neighbor bits is less than half of a constellation size associated with the communication. In some aspects, the one or more constellations includes a circular constellation, and where the set of neighbor bits are shaped in a circle around the bit or shaped in a square around the bit.

At 1206, the network entity may transmit, for the wireless device, the communication after the MCS configuration is transmitted. For example, the network entity 804 may transmit, for the wireless device, the communication 812 after the MCS configuration 810 is transmitted. In some aspects, 1206 may be performed by LLR component 199.

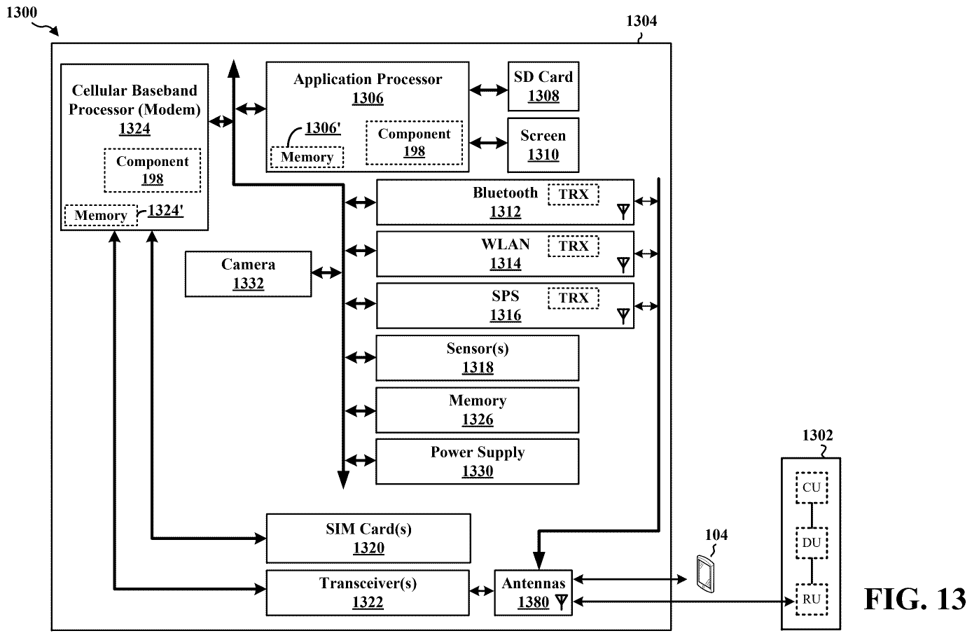

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, a satellite system module 1316 (e.g., GNSS module), one or more sensor modules 1318 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the satellite system module 1316 may include an on-chip transceiver (TRX)/receiver (RX). The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described herein. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed herein, the LLR component 198 may be configured to transmit, for a network entity, an indication representing support of one or more constellations associated with a multi-dimensional LLR calculation. In some aspects, the LLR component 198 may be further configured to obtain a MCS configuration for each constellation of the one or more constellations. In some aspects, the LLR component 198 may be further configured to receive, from the network entity, a communication after the MCS configuration is obtained. In some aspects, the LLR component 198 may be further configured to decode the communication based on the MCS configuration and the multi-dimensional LLR calculation based on a set of neighbor bits for a bit in the communication, where a quantity of the set of neighbor bits is associated with the MCS configuration. The LLR component 198 may be within the cellular baseband processor 1324, the application processor 1306, or both the cellular baseband processor 1324 and the application processor 1306. The LLR component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for transmitting, for a network entity, an indication representing support of one or more constellations associated with a multi-dimensional LLR calculation. In some aspects, the apparatus 1304 may further include means for obtaining a MCS configuration for each constellation of the one or more constellations. In some aspects, the apparatus 1304 may further include means for receiving, from the network entity, a communication after the MCS configuration is obtained. In some aspects, the apparatus 1304 may further include means for decoding the communication based on the MCS configuration and the multi-dimensional LLR calculation based on a set of neighbor bits for a bit in the communication, where a quantity of the set of neighbor bits is associated with the MCS configuration. In some aspects, the apparatus 1304 may further include means for dividing, for the bit, the set of neighbor bits into a first subset of neighbor bits of value zero and a second subset of neighbor bits of value one. In some aspects, the apparatus 1304 may further include means for performing the multi-dimensional LLR calculation for the bit based on the first subset of neighbor bits and the second subset of neighbor bits. In some aspects, the apparatus 1304 may further include means for determining the quantity of the set of neighbor bits based on a largest bit distance from the bit to a first neighbor bit of value zero and a second neighbor bit of value one. In some aspects, the apparatus 1304 may further include means for determining and storing, for the bit, the first subset of neighbor bits of value zero in the set of neighbor bits and determine a third subset of neighbor bits of value zero. In some aspects, the apparatus 1304 may further include means for performing the multi-dimensional LLR calculation for the bit based on the first subset of neighbor bits and the third subset of neighbor bits. The means may be the LLR component 198 of the apparatus 1304 configured to perform the functions recited by the means. As described herein, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

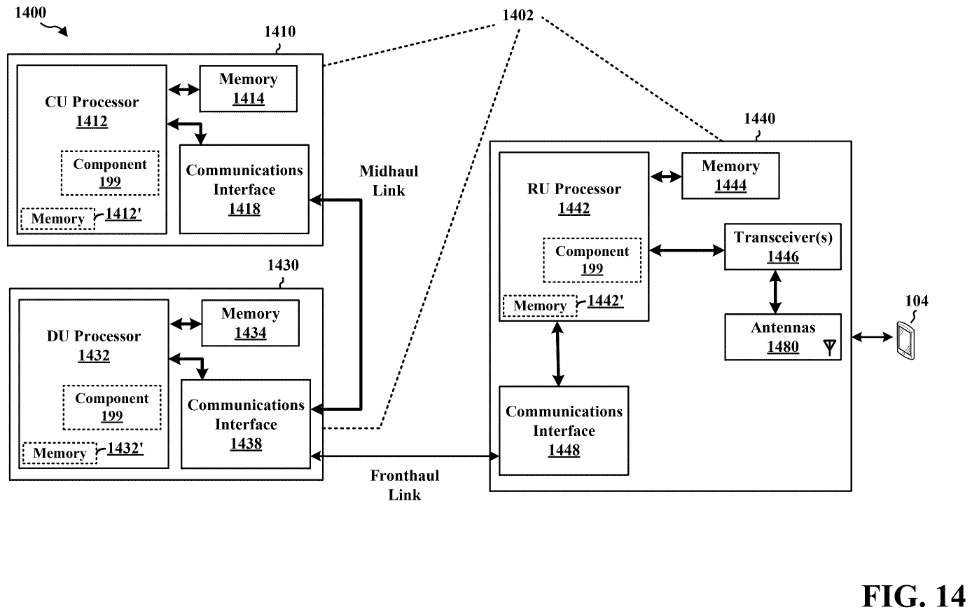

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the LLR component 199 may be configured to obtain an indication representing support of one or more constellations associated with multi-dimensional LLR calculation associated with a wireless device. In some aspects, the LLR component 199 may be further configured to transmit, for the wireless device, a MCS configuration for each constellation of the one or more constellations for decoding a communication based on a set of neighbor bits for a bit in the communication, where a quantity of the set of neighbor bits is associated with the MCS configuration. In some aspects, the LLR component 199 may be further configured to transmit, for the wireless device, the communication after the MCS configuration is transmitted. The LLR component 199 may be within one or more processors of one or more of the CU 1410, DU 1430, and the RU 1440. The LLR component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for obtaining an indication representing support of one or more constellations associated with multi-dimensional LLR calculation associated with a wireless device. In some aspects, the network entity 1402 may further include means for transmitting, for the wireless device, a MCS configuration for each constellation of the one or more constellations for decoding a communication based on a set of neighbor bits for a bit in the communication, where a quantity of the set of neighbor bits is associated with the MCS configuration. In some aspects, the network entity 1402 may further include means for transmitting, for the wireless device, the communication after the MCS configuration is transmitted. The means may be the LLR component 199 of the network entity 1402 configured to perform the functions recited by the means. As described herein, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means. It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is an apparatus for wireless communication at a wireless device, including: a memory; and at least one processor coupled to the memory and, based at least in part on information stored in the memory, the at least one processor is configured to: transmit, for a network entity, an indication representing support of one or more constellations associated with a multi-dimensional LLR calculation; obtain a MCS configuration for each constellation of the one or more constellations; receive, from the network entity, a communication after the MCS configuration is obtained; and decode the communication based on the MCS configuration and the multi-dimensional LLR calculation based on a set of neighbor symbols for a symbol in the communication, where a quantity of the set of neighbor symbols is associated with the MCS configuration.
Aspect 2 is the apparatus of aspect 1, where the multi-dimensional LLR calculation includes a 2D LLR calculation.
Aspect 3 is the apparatus of any of aspects 1-2, where the one or more constellations include at least one of: a circular constellation, a hexagonal constellation, or a constellation for multi-level coding.
Aspect 4 is the apparatus of any of aspects 1-3, where the MCS configuration is an MCS table constructed for the wireless device.
Aspect 5 is the apparatus of any of aspects 1-4, where the quantity of the set of neighbor symbols is less than half of a constellation size associated with the communication.
Aspect 6 is the apparatus of any of aspects 1-5, where to decode the communication, the at least one processor is configured to: divide, for the symbol, the set of neighbor symbols into a first subset of neighbor symbols of value zero and a second subset of neighbor symbols of value one; and perform the multi-dimensional LLR calculation for the symbol based on the first subset of neighbor symbols and the second subset of neighbor symbols.
Aspect 7 is the apparatus of aspect 6, where to decode the communication, the at least one processor is configured to: determine the quantity of the set of neighbor symbols based on a largest symbol distance from the symbol to a first neighbor bit of value zero and a second neighbor bit of value one.
Aspect 8 is the apparatus of aspect 7, where the quantity is equal to the largest symbol distance multiplied by the largest symbol distance.
Aspect 9 is the apparatus of aspect 6, where to decode the communication, the at least one processor is configured to: determine and store, for the symbol, the first subset of neighbor symbols of value zero in the set of neighbor symbols and determine a third subset of neighbor symbols of value zero; and perform the multi-dimensional LLR calculation for the symbol based on the first subset of neighbor symbols and the third subset of neighbor symbols.
Aspect 10 is the apparatus of any of aspects 1-9, where the one or more constellations includes a circular constellation, and where the set of neighbor symbols are shaped in a circle around the symbol or shaped in a square around the symbol.
Aspect 11 is the apparatus of any of aspects 1-10, where to obtain the MCS configuration for each constellation of the one or more constellations, the at least one processor is configured to: receive, from the network entity, the MCS configuration for each constellation of the one or more constellations.
Aspect 12 is the apparatus of any of aspects 1-11, further including a transceiver or an antenna coupled to the at least one processor, where the at least one processor is configured to receive the MCS configuration via the transceiver or the antenna.
Aspect 13 is an apparatus for wireless communication at a network entity, including: a memory; and at least one processor coupled to the memory and, based at least in part on information stored in the memory, the at least one processor is configured to: obtain an indication representing support of one or more constellations associated with multi-dimensional LLR calculation associated with a wireless device; transmit, for the wireless device, a MCS configuration for each constellation of the one or more constellations for decoding a communication based on a set of neighbor symbols for a symbol in the communication, where a quantity of the set of neighbor symbols is associated with the MCS configuration; and transmit, for the wireless device, the communication after the MCS configuration is transmitted.
Aspect 14 is the apparatus of aspect 13, where the multi-dimensional LLR calculation includes 2D LLR calculation.
Aspect 15 is the apparatus of any of aspects 13-14, where the one or more constellations include at least one of: a circular constellation, a hexagonal constellation, or a constellation for multi-level coding.
Aspect 16 is the apparatus of any of aspects 13-15, where the MCS configuration is an MCS table constructed for the wireless device.
Aspect 17 is the apparatus of any of aspects 13-16, where the quantity of the set of neighbor symbols is less than half of a constellation size associated with the communication.
Aspect 18 is the apparatus of any of aspects 13-17, where the one or more constellations includes a circular constellation, and where the set of neighbor symbols are shaped in a circle around the symbol or shaped in a square around the symbol.
Aspect 19 is the apparatus of any of aspects 13-18, where to obtain the indication representing support of the one or more constellations, the at least one processor is configured to: receive, from the wireless device, the indication representing support of the one or more constellations.
Aspect 20 is the apparatus of any of aspects 13-19, further including a transceiver or an antenna coupled to the at least one processor, where the at least one processor is configured to transmit the MCS configuration via the transceiver or the antenna.
Aspect 21 is a method of wireless communication for implementing any of aspects 1 to 12.
Aspect 22 is an apparatus for wireless communication including means for implementing any of aspects 1 to 12.
Aspect 23 is a computer-readable medium (e.g., a non-transitory computer-readable medium) storing computer executable code, where the code when executed by a processor causes the processor to implement any of aspects 1 to 12.
Aspect 24 is a method of wireless communication for implementing any of aspects 13 to 20.
Aspect 25 is an apparatus for wireless communication including means for implementing any of aspects 13 to 20.
Aspect 26 is a computer-readable medium (e.g., a non-transitory computer-readable medium) storing computer executable code, where the code when executed by a processor causes the processor to implement any of aspects 13 to 20.

1. An apparatus for wireless communication at a wireless device, comprising:
a memory; and
at least one processor coupled to the memory and, based at least in part on information stored in the memory, the at least one processor is configured to:
transmit, for a network entity, an indication representing support of one or more constellations associated with a multi-dimensional log-likelihood ratio (LLR) calculation;
obtain a modulation and coding scheme (MCS) configuration for each constellation of the one or more constellations;
receive, from the network entity, a communication after the MCS configuration is obtained; and
decode the communication based on the MCS configuration and the multi-dimensional LLR calculation based on a set of neighbor bits for a bit in the communication, wherein a quantity of the set of neighbor bits is associated with the MCS configuration.

2. The apparatus of claim 1, wherein the multi-dimensional LLR calculation comprises a two-dimensional (2D) LLR calculation.

3. The apparatus of claim 1, wherein the one or more constellations comprise at least one of: a circular constellation, a hexagonal constellation, or a constellation for multi-level coding.

4. The apparatus of claim 1, wherein the MCS configuration is an MCS table constructed for the wireless device.

5. The apparatus of claim 1, wherein the quantity of the set of neighbor bits is less than half of a constellation size associated with the communication.

6. The apparatus of claim 1, wherein to decode the communication, the at least one processor is configured to:
divide, for the bit, the set of neighbor bits into a first subset of neighbor bits of value zero and a second subset of neighbor bits of value one; and
perform the multi-dimensional LLR calculation for the bit based on the first subset of neighbor bits and the second subset of neighbor bits.

7. The apparatus of claim 6, wherein to decode the communication, the at least one processor is configured to:
determine the quantity of the set of neighbor bits based on a largest bit distance from the bit to a first neighbor bit of value zero and a second neighbor bit of value one.

8. The apparatus of claim 7, wherein the quantity is equal to the largest bit distance multiplied by the largest bit distance.

9. The apparatus of claim 6, wherein to decode the communication, the at least one processor is configured to:
determine and store, for the bit, the first subset of neighbor bits of value zero in the set of neighbor bits and determine a third subset of neighbor bits of value zero; and
perform the multi-dimensional LLR calculation for the bit based on the first subset of neighbor bits and the third subset of neighbor bits.

10. The apparatus of claim 1, wherein the one or more constellations comprises a circular constellation, and wherein the set of neighbor bits are shaped in a circle around the bit or shaped in a square around the bit.

11. The apparatus of claim 1, wherein to obtain the MCS configuration for each constellation of the one or more constellations, the at least one processor is configured to: receive, from the network entity, the MCS configuration for each constellation of the one or more constellations.

12. The apparatus of claim 1, further comprising a transceiver or an antenna coupled to the at least one processor, wherein the at least one processor is configured to receive the MCS configuration via the transceiver or the antenna.

13. An apparatus for wireless communication at a network entity, comprising:
a memory; and
at least one processor coupled to the memory and, based at least in part on information stored in the memory, the at least one processor is configured to:
obtain an indication representing support of one or more constellations associated with multi-dimensional log-likelihood ratio (LLR) calculation associated with a wireless device;
transmit, for the wireless device, a modulation and coding scheme (MCS) configuration for each constellation of the one or more constellations for decoding a communication based on a set of neighbor bits for a bit in the communication, wherein a quantity of the set of neighbor bits is associated with the MCS configuration; and
transmit, for the wireless device, the communication after the MCS configuration is transmitted.

14. The apparatus of claim 13, wherein the multi-dimensional LLR calculation comprises two-dimensional (2D) LLR calculation.

15. The apparatus of claim 13, wherein the one or more constellations comprise at least one of: a circular constellation, a hexagonal constellation, or a constellation for multi-level coding.

16. (canceled)

17. The apparatus of claim 13, wherein the quantity of the set of neighbor bits is less than half of a constellation size associated with the communication.

18. The apparatus of claim 13, wherein the one or more constellations comprises a circular constellation, and wherein the set of neighbor bits are shaped in a circle around the bit or shaped in a square around the bit.

19. The apparatus of claim 13, wherein to obtain the indication representing support of the one or more constellations, the at least one processor is configured to:
receive, from the wireless device, the indication representing support of the one or more constellations.

20. The apparatus of claim 13, further comprising a transceiver or an antenna coupled to the at least one processor, wherein the at least one processor is configured to transmit the MCS configuration via the transceiver or the antenna.

21. A method of wireless communication at a wireless device, comprising:
transmitting, for a network entity, an indication representing support of one or more constellations associated with a multi-dimensional log-likelihood ratio (LLR) calculation;
obtaining a modulation and coding scheme (MCS) configuration for each constellation of the one or more constellations;
receiving, from the network entity, a communication after the MCS configuration is obtained; and
decoding the communication based on the MCS configuration and the multi-dimensional LLR calculation based on a set of neighbor bits for a bit in the communication, wherein a quantity of the set of neighbor bits is associated with the MCS configuration.

22-30. (canceled)
